(19) United States
(12) Patent Application Publication
(10) Pub. No.: US 2024/0278056 A1
(43) Pub. Date: Aug. 22, 2024

(54) PFAS DESTRUCTION IN AN ALKALINE, HYDROTHERMAL ENVIRONMENT, AND RELATED METHODS AND SYSTEMS

(71) Applicant: AQUAGGA, INC., Tacoma, WA (US)

(72) Inventors: Brian Pinkard, University Place, WA (US); Mike Czerski, Seattle, WA (US); Alex De Marne, Mountlake Terrace, WA (US); Joshua MacEachern, Tualatin, OR (US)

(73) Assignee: AQUAGGA, INC., Tacoma, WA (US)

(21) Appl. No.: 18/568,852

(22) PCT Filed: Jun. 29, 2022
(86) PCT No.: PCT/US22/73254

§ 371 Date: Dec. 11, 2023

Related U.S. Application Data
(60) Provisional application No. 63/217,602, filed on Jul. 1, 2021.
(60) Provisional application No. 63/252,874, filed on Oct. 6, 2021.

(51) Int. Cl. A62D 3/34; A62D 3/35; A62D 3/36; A62D 3/40; A62D 101/22

(52) U.S. Cl. CPC A62D 3/34; A62D 3/35; A62D 3/36; A62D 3/40; A62D 2101/22; A62D 2203/02

(57) ABSTRACT

A system for breaking down a PFA (perfluoroalkyl or polyfluoroalkyl) compound includes a reactor vessel, a heater, and a catalyst. The reactor vessel is operable to hold influent that includes a PFA compound, an alkali, and water, while alkaline hydrolysis separates a fluorine atom from the PFA compound in the influent. The heater is operable to heat the influent to a temperature within the range of 100° Celsius to 700° Celsius. And the catalyst is operable to increase the rate at which alkaline hydrolysis separates a fluorine atom from a PFA compound. The catalyst includes a body that includes a transition metal, which is a d-block metal or a metal from any of the periodic table's groups 4-11. The body also has a shape configured to multiply a surface-area-to-volume ratio by at least 1.5 when the body is disposed in an influent experiencing alkaline hydrolysis.

### CROSS-REFERENCE TO RELATED APPLICATIONS AND INCORPORATION BY REFERENCE

This application claims priority from PCT Patent Application PCT/US22/73254 filed 29 Jun. 2022 and titled “Pfas Destruction In An Alkaline, Hydrothermal Environment, And Related Methods And Systems”, and U.S. Provisional Patent Applications 63/217,602 filed 1 Jul. 2021 and titled “Method and Systems for Catalytic Enhancement of PFAS Destruction in an Alkaline, Hydrothermal Environment”, and 63/252,874 filed 6 Oct. 2021 and titled “Method and System for Recycling Sodium Hydroxide in a Hydrothermal Alkaline Treatment Reactor System”. This application also incorporates by this reference the entirety of this PCT patent application and each of these U.S. Provisional patent applications.

This invention was made with government support under grant number 2037740 awarded by the National Science Foundation. The government has certain rights in the invention.

### BACKGROUND

Widespread use of per- and polyfluoroalkyl substances (PFAS), which include a perfluoroalkyl and/or a polyfluoroalkyl (PFA) compound, in manufacturing processes, consumer goods, and firefighting foams has directly contributed to contamination of groundwater, soil, biosolids, and municipal drinking water supplies at concentrations significantly exceeding recommended exposure levels. In particular, the discharge of aqueous film-forming foams (AFFF) for firefighting training at military bases, airports, hydrocarbon storage facilities, and firefighter training centers has contributed to the water and soil contamination problem. Because PFAS are known carcinogens, even in the low parts per trillion (ppt) range, the federal and many state governments are regulating the use and existence of PFAS to reduce the amount of PFAS in drinking water and environmental discharge.

Many PFAS are perpetually stable in the environment because the C—F bond, which is the backbone of PFA compounds, is a very stable bond. PFAS-rich liquids from soil remediation, along with contaminated groundwater from firefighter training pits or wells, frequently require secondary treatment. Often, adsorbent media, such as granulated activated carbon (GAC) or ion exchange resins (IXR) are used to pull PFAS from contaminated water. GAC struggles to capture short-chain PFAS (such as perfluorobutanoic acid (PFBA)), which are less hydrophobic. Spent sorbents must eventually be disposed of in a landfill or incinerator, risking environmental re-contamination. Alternatively, reverse osmosis (RO), foam fractionation, or regenerable sorbent systems do not produce any solid waste, but rather produce a more concentrated, PFAS-rich liquid waste which requires treatment and disposal.

Litigation and emerging regulations are driving a search for alternative end-of-life PFAS destruction technologies. PFAS destruction technologies must facilitate complete defluorination (cleaving all C—F bonds in a PFA compound) to eliminate the risk of subsequent environmental re-contamination, or future liability. Most PFAS destruction technologies are best suited for application on liquid wastes, with low treatment volumes and high PFAS concentrations.

Several technologies have been investigated as general PFAS destruction processes, including electrochemical oxidation over boron-doped diamonds, sonochemical destruction, high-temperature incineration, alkaline hydrolysis, plasma treatment, supercritical water oxidation, and others. However, few destructive technologies have robustly demonstrated the ability to consistently and completely break all C—F bonds in a PFA compound, and several are known to produce short-chain PFAS as a treatment product. While most of the aforementioned technologies have been demonstrated to destroy perflourooctanesulfonic acid (PFOS) and perfluorooctanoic acid (PFOA), few have been demonstrated to achieve complete mineralization of all PFAS.

Alkaline Hydrolysis. Alkaline hydrolysis is an effective process for neutralizing or destroying several hazardous wastes, including chemical warfare agents (CWAs), polychlorinated biphenyls (PCBs) and all detectable PFAS molecules. Alkaline hydrolysis occurs within the subcritical liquid phase of water (typically at temperatures between 100-374° C., and at pressures between 0.1-50 MPa) amended with a suitable base, such as NaOH, KOH, LiOH, NH₄OH and/or CaOH₂. Alkaline conditions promote decomposition mechanisms for many compounds and contaminants of interest. Alkaline hydrolysis is particularly advantageous for processing PFAS-contaminated liquids and/or solids because (i) salts remain fully soluble in the subcritical phase and do not cause issues with precipitation and scale buildup, (ii) the alkaline hydrolysis process can destroy PFAS and other contaminants with greater than 99.99% destruction efficiencies and without the production of unwanted byproducts, and (iii) alkaline hydrolysis is more energy efficient than incineration of liquid wastes, or other PFAS destruction processes.

Despite being greater than 99.99% effective for PFAS destruction, several factors hinder commercial development and deployment of alkaline hydrolysis. Required reaction times are long (more than 30 minutes), high alkaline concentrations are needed (around 5 mol/L [M] of NaOH is typical) and high temperatures are needed (around 350° C.). Long reaction times necessitate the construction of large reactors, and the alkaline and high-temperature conditions promote corrosion of most materials, including specialty alloys. In addition, the alkaline and high-pressure environment promotes stress corrosion cracking due to the mechanical stress of the high-pressure environment.

Thus, there is a need for a more effective way to breakdown/destroy PFA compounds found in PFAS.

### SUMMARY

In one aspect of the invention, a catalyst for breaking down a PFA (perfluoroalkyl or polyfluoroalkyl) compound includes a body operable to increase the rate at which alkaline hydrolysis separates a fluorine atom from a PFA compound, when the body is disposed in an influent experiencing alkaline hydrolysis. The body includes a transition metal, which is a d-block metal or a metal from any of the periodic table's groups 4-11. The body also has a shape configured to multiply, during alkaline hydrolysis in a reactor vessel, a surface-area-to-volume ratio by at least 1.5 when the body is disposed in an influent experiencing alkaline hydrolysis. The surface area of the ratio includes the surface area of the body's shape and the surface area of the reactor vessel, that the influent contacts when the influent experiences alkaline hydrolysis. The volume used in calculating the ratio includes the volume of the influent experiencing alkaline hydrolysis in the reactor vessel.

With the transition metal and the ability to increase the surface-area-to-volume ratio during alkaline hydrolysis of a PFA compound, the ease at which alkaline hydrolysis strips away most if not all of the fluorine atoms from one or more carbon atoms of the PFA compound may be substantially increased. This allows one to reduce the duration of alkaline hydrolysis of the PFA compound. This, in turn, allows one to run alkaline hydrolysis of the PFA compound as a continuous flow process through the reactor vessel. This, in turn, also allows one to reduce the size of the reactor vessel in which the alkaline hydrolysis occurs. Increasing the ease at which alkaline hydrolysis strips away most if not all of the fluorine atoms from one or more carbon atoms of the PFA compound, also allows one to reduce the amount of alkaline used (alkaline loading) during the alkaline hydrolysis reaction, reduce the temperature at which the alkaline hydrolysis reaction occurs, or any combination of these. By reducing the temperature at which alkaline hydrolysis effectively breaks down a PFA compound, one can reduce the pressure required to keep the water from entering the gas phase during the reaction, and reduce the corrosive effect of the alkaline on the reaction vessel and related systems. In addition, by using a transition metal that has a standard reduction potential that is less than the material of the reactor vessel, the catalyst may also provide the reactor vessel cathodic protection.

In another aspect of the invention, a system for breaking down a PFA (perfluoroalkyl or polyfluoroalkyl) compound includes a reactor vessel, a heater, and a catalyst. The reactor vessel is operable to hold influent that includes a PFA compound, an alkali, and water, while alkaline hydrolysis separates a fluorine atom from the PFA compound in the influent. The reactor vessel is sized and configured to reduce corrosion and maintain pressure on the influent to prevent the water in the influent from entering the gas phase during alkaline hydrolysis. The heater is operable to heat the influent to a temperature within the range of 100° Celsius to 700° Celsius. And the catalyst includes a body operable to increase the rate at which alkaline hydrolysis separates a fluorine atom from a PFA compound when the body is disposed in an influent experiencing alkaline hydrolysis. The body includes a transition metal, and has a shape configured to increase, during alkaline hydrolysis in the reactor vessel, a surface-area-to-volume ratio by at least 1.5 when the body is disposed in an influent experiencing alkaline hydrolysis. The surface area of the ratio includes the surface area of the body's shape and the surface area of the reactor vessel, that the influent contacts when the influent experiences alkaline hydrolysis. And, the volume of the ratio includes the volume of the influent experiencing alkaline hydrolysis in the reactor vessel.

In yet another aspect of the invention, a method for breaking down a PFA (perfluoroalkyl or polyfluoroalkyl) compound includes the following: a) adding an alkali to a solution that includes a PFA compound to generate a mixture; b) pressurizing the influent to a pressure that prevents the water in the influent from entering the gas phase; c) heating the influent to a temperature within the range of 100° Celsius to 700° Celsius; d) holding the influent in a reactor vessel that includes a catalyst disposed in the influent; and, e) maintaining the temperature and pressure of the influent for a period of time to separate a fluorine atom from the PFA compound via alkaline hydrolysis.

### BRIEF DESCRIPTION OF THE DRAWINGS

FIG. 1 shows a schematic view of a system for breaking down a PFA compound, according to an embodiment of the invention.

FIG. 2 shows a schematic view of a method for breaking down a PFA compound that the system shown in FIG. 1 performs, according to an embodiment of the invention.

FIG. 3 shows a perspective view of a catalyst included in the system shown in FIG. 1, according to an embodiment of the invention.

FIG. 4 shows a perspective view of another catalyst, according to another embodiment of the invention.

FIG. 5 shows a schematic view of another system for breaking down a PFA compound, according to another embodiment of the invention.

FIG. 6 shows a schematic view of another method for breaking down a PFA compound that the system shown in FIG. 5 performs, according to an embodiment of the invention.

FIG. 7 shows a table that illustrates a correlation between surface-area-to-volume ratios during alkaline hydrolysis and PFA compound destruction performance, according to an embodiment of the invention.

FIG. 8 shows a graph that illustrates corrosion protection that a catalyst can provide a reactor vessel, according to an embodiment of the invention.

### DETAILED DESCRIPTION

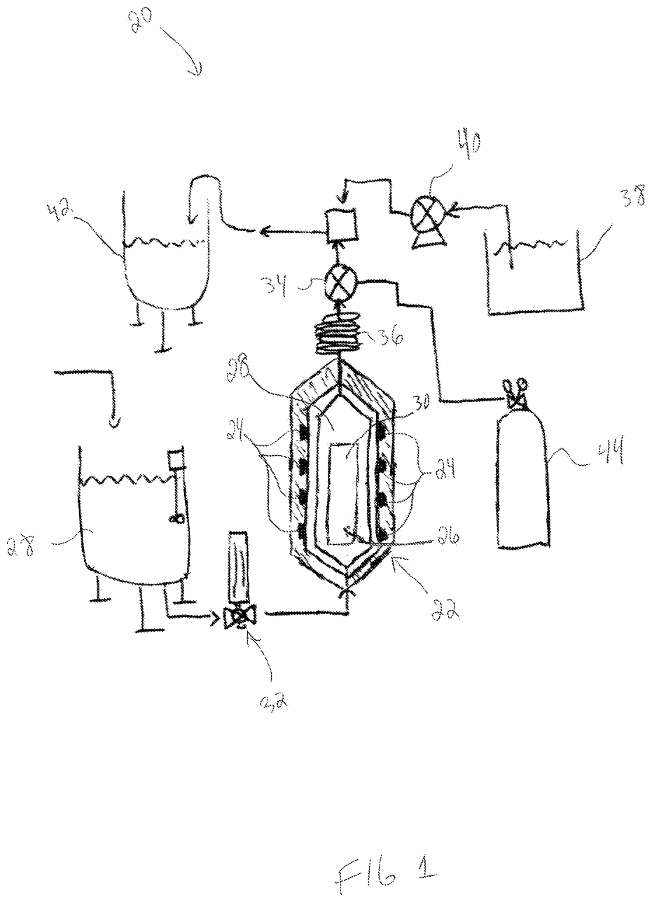

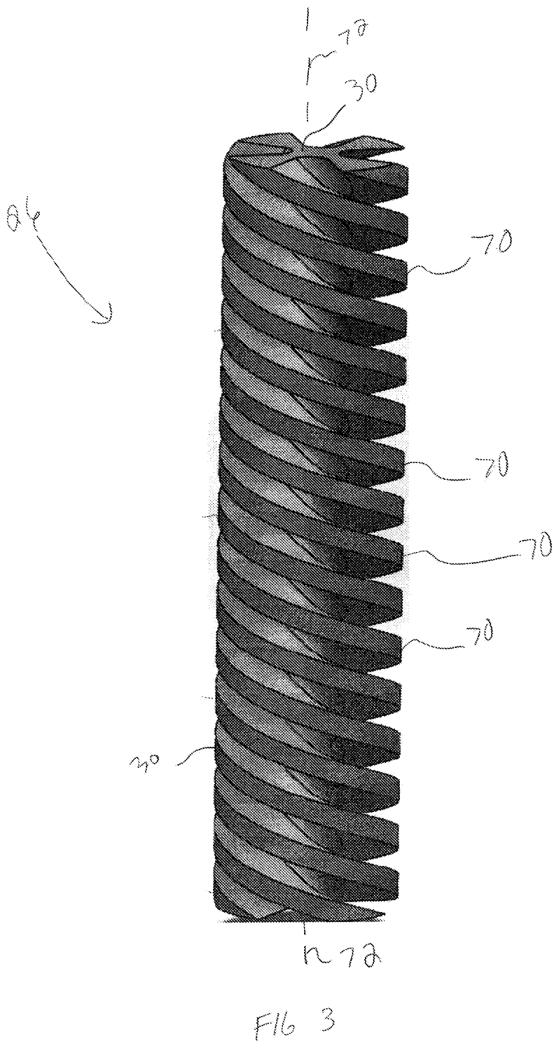

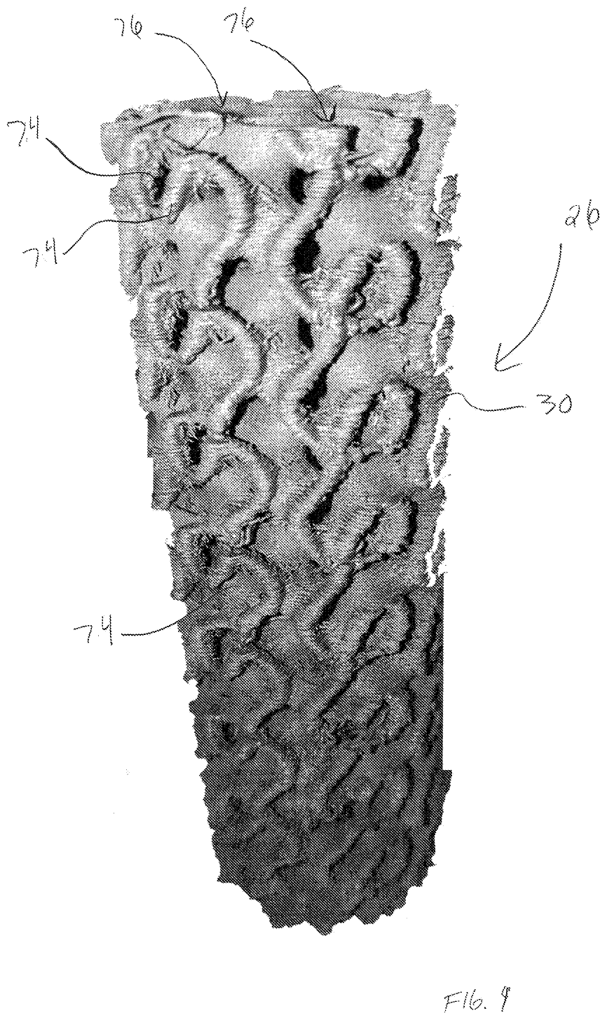

FIG. 1 shows a schematic view of a system 20 for breaking down a PFA (perfluoroalkyl or polyfluoroalkyl) compound (not shown), according to an embodiment of the invention. Here the PFA compound is perflourooctanesulfonic acid (PFOS), but the PFA compound may be any per- or poly-fluoroalkyl substance (PFAS). The system 20 includes a reactor vessel 22, a heater 24, and a catalyst 26. The reactor vessel 22 holds influent 28 that includes a PFA compound, an alkali, and water, while the influent 28 undergoes alkaline hydrolysis to separate a fluorine atom from the PFA compound in the influent 28. The heater 24 is operable to heat the influent 28 to a temperature within the range of 100° C. to 700° C. And, the catalyst 26 (discussed in greater detail in conjunction with FIGS. 3 and 4) makes it easier for alkaline hydrolysis to separate a fluorine atom from a PFA compound. The catalyst 26 has a body 30 that includes a transition metal, and has a shape configured to increase, during alkaline hydrolysis in the reactor vessel 22, a surface-area-to-volume ratio by at least 1.5. The surface-area portion of the ratio includes the surface area of the body's shape and the surface area of the reactor vessel 22, that the influent 28 contacts when the influent 28 experiences alkaline hydrolysis. And, the volume portion of the ratio includes the volume of the influent 28 experiencing alkaline hydrolysis in the reactor vessel 22.

With the transition metal and the ability to increase the surface-area-to-volume ratio during alkaline hydrolysis of a PFA compound, the ease at which alkaline hydrolysis strips away most if not all of the fluorine atoms from one or more carbon atoms of the PFA compound may be substantially increased. This allows one to reduce the duration of the alkaline hydrolysis of the PFA compound. This, in turn, allows one to run the alkaline hydrolysis of the PFA compound as a continuous flow process through the reactor vessel 22. This, in turn, also allows one to reduce the size of the reactor vessel 22 in which the alkaline hydrolysis occurs. Increasing the ease at which alkaline hydrolysis strips away most if not all of the fluorine atoms from one or more carbon atoms of the PFA compound, also allows one to reduce the amount of alkali used (alkaline loading) during the alkaline hydrolysis reaction, reduce the temperature at which the alkaline hydrolysis reaction occurs, or any combination of these. By reducing the temperature at which alkaline hydrolysis effectively breaks down a PFA compound, one can reduce the pressure required to keep the water from entering the gas phase during the reaction, and reduce the corrosive effect of the alkaline on the reaction vessel 22 and related systems. In addition, by using a transition metal that has a standard reduction potential that is less than the material of the reactor vessel 22, the catalyst 26 may also provide the reactor vessel 22 cathodic protection.

The transition metal included in the catalyst's body 30 is a metal that includes one or more of the elements located in one of the groups 4-11 of the periodic table of elements. Transition metals are elements that have more than one electron in their valence shell—outermost shell of electrons—that can participate in the formation of bonds with other elements. Because of this, transition metals are able to adopt multiple oxidation states and form a wide range of complex ions in various oxidation states. Examples of metals from groups 4-11 of the periodic table include titanium, chromium, iron, nickel, copper, zirconium, gold, hafnium, silver, rutherfordium, and roentgenium. The transition metal in the catalyst's body 30 may be in its elemental form, form an alloy with one or more other metals, and/or form a compound with an element that is not a metal.

Alkaline hydrolysis of a PFA compound is a reaction in which a negative ion attacks the hydrophilic functional group of a PFA compound. Here, in this example, the PFA compound is PFOS, and the negative ion is a hydroxide ion (OH⁻) from sodium hydroxide (NaOH). In PFOS, sulfonic acid is the hydrophilic functional group of the compound and is attached to an end carbon of an eight-carbon chain molecule. All of the remaining available bonds to carbon are taken by fluorine atoms and together form the hydrophobic fluorinated tail of the PFOS compound. During alkaline hydrolysis of the PFOS compound, the OH⁻ ion attacks the bond between the sulfonic acid group and the end carbon, and replaces the sulfonic acid on the end carbon. With just an OH⁻ ion at the carbon end, the compound then undergoes hydration and hydrogen-fluorine (HF) elimination to produce short-chain perfluorocarboxylates and ultimately stable end-products. Sodium ions from the sodium hydroxide combine with the eliminated (freed) HF molecules to neutralize the HF molecules and form aqueous NaF.

The alkali that forms a portion of the influent 28 may be any desired alkali, such as a hydroxide. For example, in this embodiment, the alkali includes sodium hydroxide (NaOH). In other embodiments, the alkali includes potassium hydroxide (KOH), and/or ammonium hydroxide (NH₄OH).

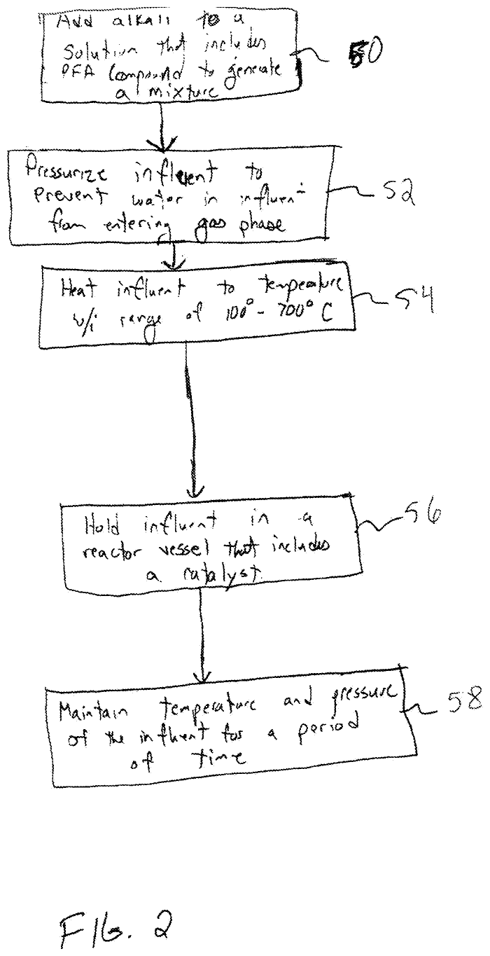

Still referring to FIG. 1, the reactor vessel 22 may be configured as desired to hold the influent 28 during alkaline hydrolysis under the reaction conditions discussed in conjunction with FIG. 2—specifically 100° C. to 700° C., and 0.1 MPa to 50 MPa. For example, in this and other embodiments the reactor vessel 22 is made of a material that resists corrosion in the caustic environment that the alkaline hydrolysis occurs in. More specifically, the material may include a nickel alloy, such as Inconel 625 or Inconel 600. This material also provides good strength to withstand the high pressures that the alkaline hydrolysis may be performed at. The reactor vessel 22 also has a cylindrical shape to facilitate the flow of influent through the reactor while the influent undergoes the reaction, and a mount to releasably anchor the catalyst 26 in the vessel 22. In this configuration, the influent 28 continuously flows through the reactor vessel 22 while it undergoes alkaline hydrolysis, and in some embodiments, takes one minute to flow through the reactor vessel 22. Also, the reactor vessel 22 is configured to house the heater 24 so that the influent is heated to the desired reaction temperature while influent flows through the reactor vessel 22. In other embodiments, the reactor vessel 22 may not be configured to facilitate flow through it, but rather configured to promote the alkaline hydrolysis reaction of the influent 28 in a batch process where influent is kept in the reactor vessel 22 and not allowed to flow through the reactor vessel 22 until the reaction completes, and then removed from the reactor vessel 22. In such configurations the reactor vessel 22 may be spherical. In still other embodiments, the reactor vessel 22 may not be configured to house the heater 24, and instead the heater 24 may be located upstream from the reactor vessel 22.

Still referring to FIG. 1, the heater 24 may be any desired heater capable of generating the heat required to increase the temperature of the influent to the temperature desired for the alkaline hydrolysis reaction. For example, in this and other embodiments the heater 24 includes an electrically resistive heating element that generates heat by resisting the flow of electricity through it. In other embodiments, the heater 24 may include a combustion chamber or nozzle and generate heat by burning a fuel such as natural gas. This allows the system 20 to operate in locales that do not have an adequate, if any, supply of electricity.

Still referring to FIG. 1, the system 20 also includes other components each of which may be configured as desired. For example, in this and other embodiments, the system 20 includes a pump 32, a back-pressure regulator 34, a heat exchanger 36, an acid reservoir 38, and a metering device 40. The pump 32 pressurizes the influent 28 and urges the influent 28 into and through the reactor vessel 22. The pressure in the influent 28 is controlled by the back-pressure regulator 34 by not allowing the influent 28 to flow rapidly through the reactor vessel 22 when the pump 32 pressurizes the influent 28, such as to 20 MPa. Because of this, the back pressure regulator 34 also functions to reduce the pressure in the effluent (influent 28 that has left the reactor vessel 22) to ambient conditions. The pressure in the effluent at which the back-pressure regulator 34 allows the effluent to flow toward the effluent discharge tank 42 is set and controlled by the flow of gas (here N₂) from the tank 44. The heat exchanger 36 removes heat from the effluent to protect downstream components of the system 20. The acid reservoir 38 and metering device 40 add acid to the effluent to lower the effluent's pH.

FIG. 2 shows a schematic view of a method for breaking down a PFA compound that the system shown in FIG. 1 performs, according to an embodiment of the invention. The method may be used to breakdown any PFA compound. For example, the PFA compound may be perfluorooctanoic acid (PFOA), perfluorocarboxylic acid (PFCA), and/or fluorotelomer alcohols (FTOH). As previously mentioned, the PFA compound referenced in this discussion of the method is perflourooctanesulfonic acid (PFOS).

In this and other embodiments of the method, the first step 50 in the method includes combining a liquid or slurry containing PFOS with an alkali (here NaOH) to generate a mixture. Most liquids or slurries that contain a PFA compound include enough water to promote alkaline hydrolysis. If, however, the liquid or slurry containing the PFA compound does not, then water may be added to the alkali-liquid/slurry mixture. In other embodiments adding water may be required where the PFA compound is in a sludge or more solid form than a slurry. After the alkali and liquid or slurry are combined, and water, if added, has been added, the combination becomes influent 28 that is further processed in the method. The next step 52 of the method includes pressurizing the influent 28 to prevent the water in the influent 28 from entering the gas phase when the influent is heated. In this and other embodiments, the pump 32 (FIG. 1) pressurizes the influent 28. The following step 54 includes heating the influent 28 to a temperature within the range of 100° C. to 700° C. The steps 52 and 54 may be done in reverse order or at the same time. However, if the influent 28 is to be heated to above the water's boiling point, then the order of the steps should not be reversed. The next step 56 of the method includes holding the influent 28 in the reactor vessel 22 (FIG. 1) that includes a catalyst 26 (FIG. 1). In this embodiment, the influent 28 is urged to flow into and through the reactor vessel 22 while the influent 28 undergoes alkaline hydrolysis in the presence of the catalyst 26. Thus, holding here means confining the influent 28 in the reactor vessel 22 while it flows through the vessel 22, not stopping the flow of influent 28 inside the vessel 22. Then, inside the reactor vessel 22 at step 58, the temperature and pressure of the influent 28 is maintained for a period of time to allow alkaline hydrolysis to strip away most if not all the fluorine atoms from their corresponding carbon atom in the PFOS. In this and other embodiments, with the influent 28 continually flowing through the reactor vessel 22 during alkaline hydrolysis, the heating step 54 may be performed inside the reactor vessel 22. In other embodiments, the pressurizing and heating steps 52 and 54, respectively, may be performed before the influent 28 reaches the vessel 22. In still other embodiments, when the influent 28 does not flow through the reactor vessel 22 while undergoing alkaline hydrolysis, the influent 28 may be pressurized and heated inside the reactor vessel 22.

As previously mentioned, the catalyst 26 substantially increases the ease at which alkaline hydrolysis breaks down PFOS. Because of this, the amount of alkali consumed in the alkaline hydrolysis reaction, or the duration, the temperature, or the pressure of the alkaline hydrolysis reaction, or any combination of these aspects of the reaction may be modified as desired. For example, one may perform the method at an elevated temperature between 150° C. and 350° C. to reduce the amount of alkali added to the PFOS and water, and thus reduce the pH of the influent 28. Or, one may perform the method at an elevated temperature between 150° C. and 350° C. without reducing the amount of alkali added, to reduce the duration of the alkaline hydrolysis of the PFOS and thus increase the rate at which PFOS is broken down. One may even perform the method at a temperature above the critical temperature of water (374° C.). When the method is performed at elevated temperatures, the influent 28 is pressurized to a pressure that prevents the water in the influent 28 from entering the gas phase. If, however, the method is performed at a temperature that is below the boiling point of water, then one can simply keep the influent 28 equal to atmospheric pressure, which eliminates the need for a pump that pressurizes the influent 28. Under these conditions, the duration of the alkaline hydrolysis increases, but the amount of energy required during the alkaline hydrolysis reaction decreases. This may be advantageous when the method is performed out in the field without any easy access to power, or to mitigate damage to the environment caused by the generation and use of power.

So, the amount of alkali combined with the PFOS and water in the influent may be any desired amount. For example, in this and other embodiments the amount of alkali ranges between 0.01 Moles per liter to 10 Moles per liter. Likewise, the pH of the influent 28 may be any desired pH. For example, in this and other embodiments the pH of the influent 28 is 13 or greater. The temperature of the influent 28 during the alkaline hydrolysis may lie within the range of 100° C. to 700° C. For example, in this and other embodiments, the temperature lies within the range 150° C. and 350° C. The pressure of the influent 28 during alkaline hydrolysis may lie within the range of 0.1 to 50 MPa. For example, in this and other embodiments the pressure is 10 MPa. The duration that the temperature and pressure of the influent 28 is maintained in the method may be any desired duration. For example, in this and other embodiments the duration of the temperature and pressure lies within the range of 1 to 10 minutes.

Each of FIGS. 3 and 4 shows a perspective view of a catalyst 26 included in the system 20 shown in FIG. 1, each according to a different embodiment of the invention. The catalyst 26 has a body 30 that includes a transition metal, and has a shape configured to increase a surface-area-to-volume ratio by at least 1.5. The combination of these two aspects makes it easier for alkaline hydrolysis to separate a fluorine atom from a PFA compound.

The transition metal that is included in the catalyst's body 30 may be any of the transition metals. For example, in this and certain other embodiments the body 30 includes iron. More specifically, the body 30 is made of an iron alloy—stainless steel. In the embodiment shown in FIG. 3 and in other embodiments, the stainless-steel alloy is SS430. In the embodiment shown in FIG. 4 and in other embodiments, the stainless-steel alloy is SS304 or SS316. When the body 30 of the catalyst 26 is made of an iron alloy, and the reactor vessel 22 is made of a nickel alloy, then the catalyst 26 also provides the reactor vessel 22 cathodic protection. Because iron alloy has a standard reduction potential that is less than the nickel alloy's standard reduction potential, in the presence of a voltage potential the iron in the iron alloy will give up a valence electron before the nickel in a nickel alloy will.

The surface-area portion of the ratio includes the surface area of the body's shape and the surface area of the reactor vessel 22, that the influent 28 contacts during alkaline hydrolysis inside the reactor vessel 22. And, the volume portion of the ratio includes the volume of the influent 28 experiencing alkaline hydrolysis in the reactor vessel 22. So, when influent 28 undergoes alkaline hydrolysis in a reactor vessel 22 that does not include a catalyst 26, the total surface area of the surface-area-to-volume ratio is the surface area of the inside of the reactor vessel 22 that the influent contacts during the reaction. But, when influent 28 undergoes alkaline hydrolysis in a reactor vessel 22 that includes a catalyst 26, the total surface area of the surface-area-to-volume ratio is the sum of the surface area of the catalyst and the surface area of the inside of the reactor vessel 22, that the influent 28 contacts during the reaction. Likewise, when influent 28 undergoes alkaline hydrolysis in a reactor vessel 22 that does not include a catalyst 26, the volume of the surface-area-to-volume ratio is the volume of the reactor vessel's inside cavity where the influent 28 is held (for continuous flow influent). But, when the influent 28 undergoes alkaline hydrolysis in a reactor vessel 22 that includes a catalyst 26, the volume of the surface-area-to-volume ratio is the volume of the reactor vessel's inside cavity less the volume of the catalyst 26 inside the cavity.

Still referring to FIGS. 3 and 4, the body 30 of the catalyst may be configured as desired to generate a large surface area to increase the surface-area-to-volume ratio by 1.5 times or more, and thus expose much of the influent 28 to the transition metal of the body 30 during alkaline hydrolysis. For example, in this and other embodiments the body 30 has a helical shape (FIG. 3). The helical shape may include any desired number of fins 70. In this configuration, the body 30 includes four fins 70, each running the length of the body 30 such that each fin 70 wraps around the axis 72 four times. In this configuration the body 30 has a large surface for its volume—from 12 to 110 times the body's volume. Depending on the diameter and length of the body 30, and the volume of the reactor vessel 22 that the body 30 is disposed in, the surface-area-to-volume ratio may increase by a multiple of 30 or more. The helical shape also urges the influent 28 to swirl as the influent flows through the reactor vessel 22, thus mixing the influent 28 as it undergoes alkaline hydrolysis. For another example, in the embodiment shown in FIG. 4 and other embodiments, the body 30 has a cylindrical shape that includes a rough outer surface 74, and a passage 76 (here two) through which influent may flow during alkaline hydrolysis in the reactor vessel 22. In this configuration the rough outer surface 74 creates local turbulence in the influent 28 that flows across it and thus helps mix the influent 28 during alkaline hydrolysis. Similar to the fins 70 in FIG. 3, the passages 76 cause the influent 28 that flows through them to swirl, which also helps mix the influent 28 during alkaline hydrolysis.

Other embodiments of the catalyst are possible. For example, the body 30 of the catalyst may be a mesh of wire.

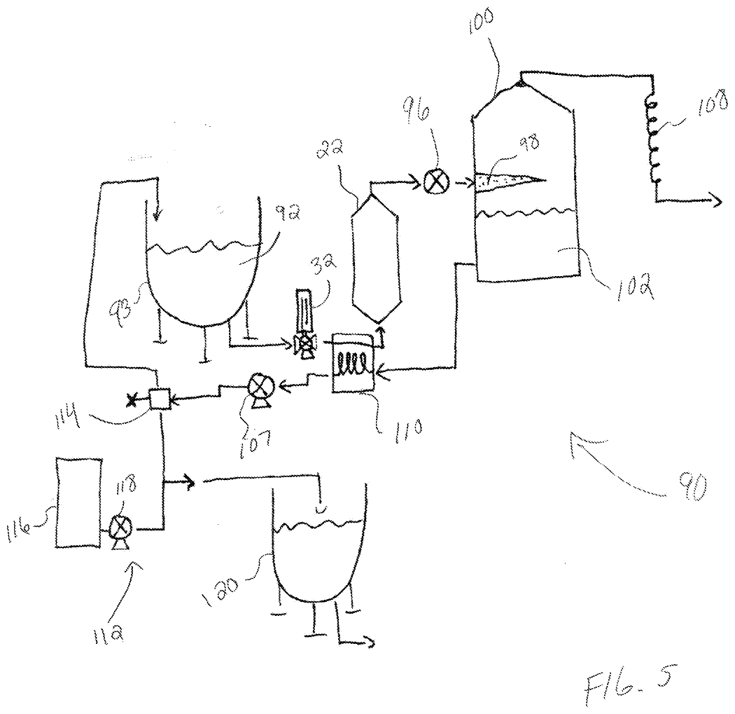

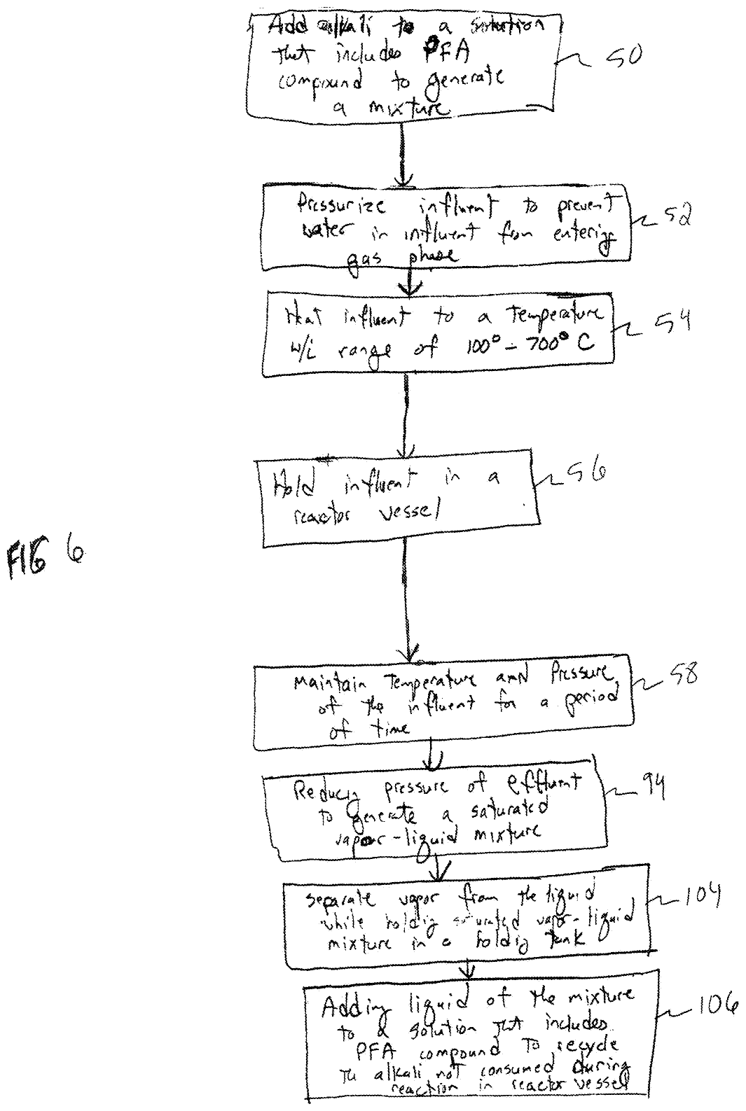

FIG. 5 shows a schematic view of another system 90 for breaking down a PFA compound, according to another embodiment of the invention. And FIG. 6 shows a schematic view of another method for breaking down a PFA compound that the system 90 shown in FIG. 5 performs, according to an embodiment of the invention.

The system 90 and the method that it performs to breakdown a PFA compound are similar to the system 20 shown in FIG. 1 and the method shown in FIG. 2, except that the system 90 does not include a catalyst disposed in its reactor vessel 22 and does include components for recycling alkali used during alkaline hydrolysis of the PFA compound, and recuperating heat from the effluent. Although the system 90 in this embodiment does not include a catalyst disposed in the reactor vessel 22, other embodiments of the system 90 do include a catalyst in the reactor vessel 22 that is similar to the catalyst 26 included in the system 20 to make it easier for alkaline hydrolysis to separate a fluorine atom from the PFA compound. In general, the difference between the method shown in FIG. 2 and the method shown in FIG. 6 is that the influent 28 essentially makes a single pass through the system 20 to breakdown most if not all of the PFA compound; while the influent 92 makes two or more passes through the system 90 to breakdown most if not all of the PFA compound. These multiple passes through the system 90 allow the alkaline loading, duration, temperature and pressure of the alkaline hydrolysis in the reactor vessel 22 to be further reduced if desired. In some embodiments of the method shown in FIG. 6, the alkali that is recycled is the alkali that is not consumed during alkaline hydrolysis. While in other embodiments, the method includes recycling most if not all of the alkali that is also consumed during alkaline hydrolysis. In such embodiments a different alkali, such as calcium hydroxide or magnesium hydroxide when sodium hydroxide is used in the alkaline hydrolysis reaction, may be added to the effluent to release the sodium atoms from their bonds with fluorine atoms and the hydrophilic functional groups of the PFA compounds (here sulfonic acid of PFOS or perflourooctanesulfonic acid).

Because the system 90 and the method shown in FIG. 6 are similar to the system 20 and the method shown in FIG. 2, respectively, the components and steps of each that are also found in the system 20 and the method shown in FIG. 2, have been referenced in FIGS. 5 and 6 with the same reference number. Also, as previously mentioned, the PFA compound referenced in this discussion of the method is perflourooctanesulfonic acid (PFOS), but the method and system 90 may work with any PFA compound.

Referring to FIGS. 5 and 6, in this and other embodiments of the method and system 90, the first step 50 includes combining a liquid or slurry containing PFOS with an alkali (here NaOH) to generate a mixture. As discussed in conjunction with FIG. 2, water may or may not be added to the mixture. After the alkali and liquid or slurry are combined, and water, if added, has been added, the combination becomes influent 92 that is further processed in the method. The next step 52 of the method includes pressurizing the influent 92 to prevent the water in the influent 92 from entering the gas phase when the influent 92 is heated. In this and other embodiments, the pump 32 (FIG. 5) pressurizes the influent 92. The following step 54 includes heating the influent 92 to a temperature within the range of 100° C. to 700° C. The steps 52 and 54 may be done in reverse order or at the same time. However, if the influent 92 is to be heated to above the water's boiling point, then the order of the steps should not be reversed. The next step 56 of the method includes holding the influent 92 in the reactor vessel 22 (FIG. 5). In this embodiment, the influent 92 is urged to flow into and through the reactor vessel 22 while the influent 92 undergoes alkaline hydrolysis. Thus, holding here means confining the influent 92 in the reactor vessel 22 while it flows through the vessel 22, not stopping the flow of influent 92 inside the vessel 22. Then, inside the reactor vessel 22 at step 58, the temperature and pressure of the influent 92 is maintained for a period of time to allow alkaline hydrolysis to strip away most if not all the fluorine atoms from their corresponding carbon atom in the PFOS. In this and other embodiments, the pressurizing and heating steps 52 and 54, respectively, may be performed before the influent 92 reaches the vessel 22. In other embodiments, with the influent 92 continually flowing through the reactor vessel 22 during alkaline hydrolysis, the heating step 54 may be performed inside the reactor vessel 22. In still other embodiments, when the influent 92 does not flow through the reactor vessel 22 while undergoing alkaline hydrolysis, the influent 92 may be pressurized and heated inside the reactor vessel 22. Then, at step 58, the temperature and pressure of the influent 92 is maintained for a period of time to allow alkaline hydrolysis to strip away fluorine atoms from their corresponding carbon atom in the PFOS. Then, at step 94, the influent pressure is reduced to generate a saturated liquid-vapor mixture of phases in the water portion of the effluent. The vapor phase 98 is shown in the tank 100, and the liquid phase is shown mixed with the reaction products, hydroxide, and remaining PFA compound, together 102. The reduction in pressure is accomplished with a throttling device 96 (FIG. 5) that restricts flow of the effluent to generate a drop in the effluent's pressure across the throttling device 96. By doing this the throttling device 96 allows the pump 32 to pressurize the influent 92 to the desired reaction pressure, and then reduces the effluent's pressure as it exits the device 96. In this and other embodiments the throttling device 96 is a back-pressure regulator like the one in system 20 (FIG. 1), but the throttling device 96 may be any desired device capable of performing this function, such as a capillary tube, or an expansion valve. The next step 104 in the method includes separating the vapor phase 98 of the water from the liquid portion 102 of the effluent. In this and other embodiments, this is accomplished by holding the effluent in the tank 100 whose volume exceeds the volume of the reactor vessel 22 so that the vapor phase 98 of the water has room to rise above the liquid effluent. The next step 106 includes directing, with a recirculation pump 107, the liquid portion 102 of the effluent back toward the vessel 93 where it can be mixed in with other influent 92 and then together urged through the system 90. The water vapor 98 in the tank 100 may be vented directly to the environment or it may be condensed to the liquid phase with a condenser 108 and then directed back toward the vessel 93 to be used again to generate influent 92 or simply discharged to the environment.

The system 90 and the method shown in FIG. 6, may also include other components. For example, in this and other embodiments the system 90 and the method include a recuperative heat exchanger 110, an acid addition system 112, and a three-way valve 114. The recuperative heat exchanger 110 absorbs heat from the liquid portion 102 of the effluent and transfers the heat to influent 92 that is about to enter the reactor vessel 22 to undergo alkaline hydrolysis, thus recycling heat previously generated for previous influent. With this addition, the amount of energy required to heat the influent 92 at step 58 may be reduced. The acid addition system 112 includes an acid reservoir 116 and metering device 118 to add acid to the liquid portion 102 of the effluent to lower its pH in preparation for discharge via the vessel 120. The three-way valve 114 controls where the liquid portion 102 of the effluent flows—to the vessel 93 to be mixed into other influent for another pass through the system 90, or to the vessel 120 to be discharged.

In addition, the system 90 and the method shown in FIG. 6, may also include a sub-system for periodically removing fluorides and sulfates (or any other hydrophilic functional group of a PFA compound) from the effluent and extend the use of sodium hydroxide (or any other hydroxide that is used in the alkaline hydrolysis reaction) in the system 90 and method. The sub-system may be located between the recirculation pump 107 and the three-way valve 114 and may include a tank that the effluent is held in while a hydroxide that is different than the one used in the alkaline hydrolysis is added to the effluent. For example, if NaOH is used in the alkaline hydrolysis reaction, then the different hydroxide may include calcium hydroxide, potassium hydroxide, or magnesium hydroxide. When the different hydroxide is added to the effluent it replaces sodium in sodium fluoride (NaF) and in sodium sulfate (Na₂SO₄). The new fluorine and sulfate salts may then be precipitated out of the effluent and set aside for further processing, and the freed sodium can combine with hydroxide ions in the effluent to form sodium hydroxide that can be directed back toward the vessel 93. The sub-system may also include a control system that tests the effluent for concentrations of sodium fluoride and sodium sulfate, and when the concentration reaches a threshold, the control system may stop the flow of effluent to the vessel 93 and add the other hydroxide to the effluent.

Still referring to FIGS. 5 and 6, the system 90 and the method may include a controller that regularly tests the influent 92 held in the vessel 93 and the effluent 102 in the tank 100 for specific concentrations of the water, alkali, PFA compound, fluorine salts, and sulfate salts, as well as mass flow rates through the reactor vessel 22, and the temperature and the pressure of the influent 92 and the effluent. Then, in response to this information, adjusts the amount of hydroxide added to the water and PFA compound, the pressure that each of the pumps 32 and 107 generate, the amount of heat generated by the heater, and the operation of the three-way valve. In addition, the system 90 and method may include a nanofiltration membrane that removes impurities from the liquid effluent leaving the tank.

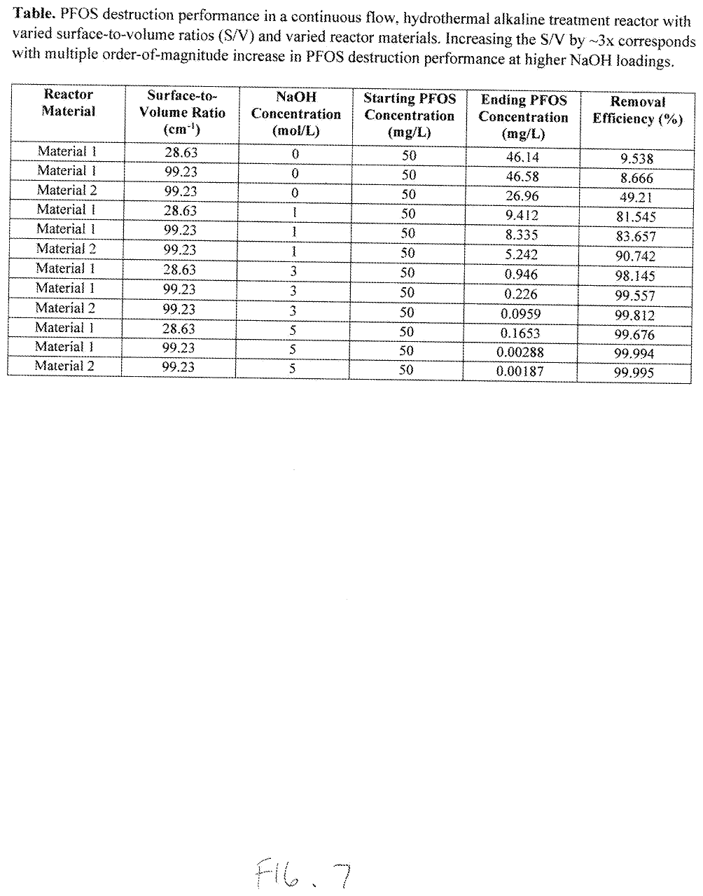

FIG. 7 shows a table that illustrates a correlation between surface-area-to-volume ratios (s/v) during alkaline hydrolysis and PFA compound destruction performance, according to an embodiment of the invention. Specifically, the table shows different PFOS destruction rates in three different situations, under four different alkaline hydrolysis conditions. The three different situations are: a reactor vessel 22 of one material that is not coupled with a catalyst 26 (s/v=28.63 cm⁻¹), a reactor vessel 22 of the same material that is coupled with a catalyst 26 (s/v=99.23 cm⁻¹), and a reactor vessel 22 of a different material that is coupled with a catalyst 26 (s/v=99.23 cm⁻¹). The difference between the four different alkaline hydrolysis conditions is the concentration of the alkali (here NaOH). This data shows that increasing the s/v during alkaline hydrolysis increases the efficiency of the reaction, regardless of the reactor vessel's and catalyst body's materials, and the alkali concentration.

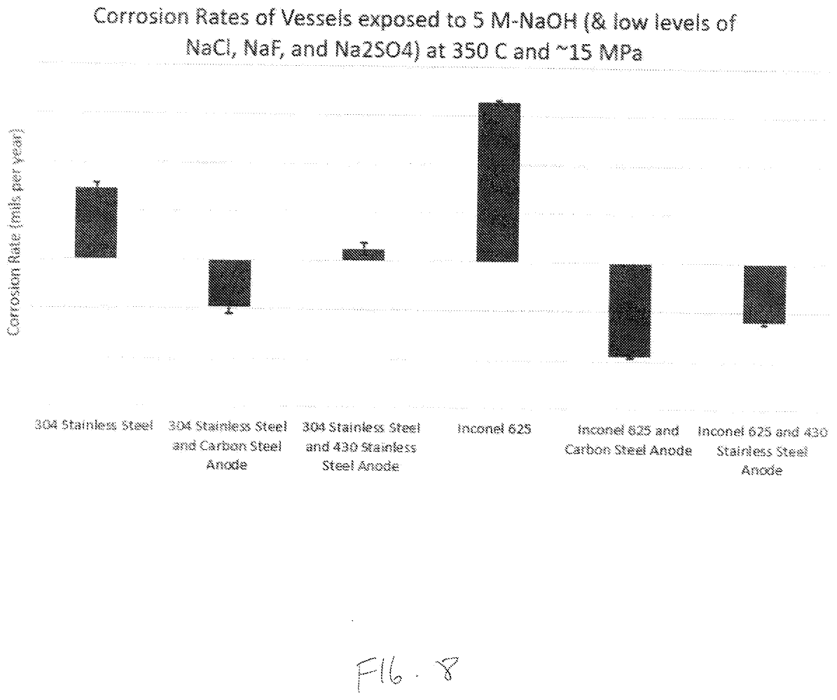

FIG. 8 shows a graph that illustrates corrosion protection that a catalyst 26 (FIG. 1) can provide a reactor vessel 22 (FIG. 1), according to an embodiment of the invention. By selecting a material for the body 30 (FIG. 1) of the catalyst 26, that has a standard reduction potential that is less than the standard reduction potential of the material that the reactor vessel 22 includes, the catalyst 26 may provide the reactor vessel 22 cathodic protection.

Specifically, the graph in FIG. 8 shows corrosion rates for a reactor vessel 22 in six different situations under the same alkaline hydrolysis conditions—5 M of NaOH (and low levels of NaCl, NaF, and Na2SO4) at 350° C. and about 15 MPa. The first situation is a reactor vessel 22 that includes 304 stainless steel alloy and is not coupled with a catalyst 26. The second situation is a reactor vessel 22 that includes 304 stainless steel alloy and is coupled with a catalyst 26 whose body 30 includes carbon steel. The third situation is a reactor vessel 22 that includes 304 stainless steel alloy and is coupled with a catalyst 26 whose body 30 includes 430 stainless steel alloy. The fourth situation is a reactor vessel 22 that includes Inconel 625 and is not coupled with a catalyst 26. The fifth situation is a reactor vessel 22 that includes Inconel 625 and is coupled with a catalyst 26 whose body 30 includes carbon steel. The sixth situation is a reactor vessel 22 that includes Inconel 625 and is coupled with a catalyst 26 whose body 30 includes 430 stainless steel alloy.

Surprisingly, the unprotected Inconel 625 vessel exhibits the highest corrosion rate of all of the tested alloys. The carbon steel body 30 of the catalyst 26 corrodes quickly, especially when coupled with a reactor vessel 22 that includes 304 stainless steel. And although a carbon steel catalyst body 30 provides the reactor vessel 22 a high degree of cathodic protection when the reactor vessel 22 includes 304 stainless steel or Inconel 625, the problem with coupling a carbon steel catalyst body 30 with an Inconel or 304 stainless steel reactor vessel 22 is that a substantial amount of the corrosion byproducts enter the effluent and have to be dealt with. The 430 stainless steel body 30 of the catalyst 26 shows a much more manageable corrosion rate, and does not exfoliate in the same way that the carbon steel body 30 does. Thus, in this and other embodiments, a catalyst 26 whose body 30 is 430 stainless steel is coupled with a reactor vessel 22 that includes Inconel 625 to provide the reactor vessel 22 good cathodic protection while reducing corrosive byproducts in the effluent that have to be dealt with.

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

1.-9. (canceled)

10. A system for breaking down a PFA (perfluoroalkyl or polyfluoroalkyl) compound, the system comprising:
a reactor vessel operable to hold influent that includes:
a PFA compound,
an alkali, and
water,
while alkaline hydrolysis separates a fluorine atom from the PFA compound in the influent, wherein, the reactor vessel is sized and configured to reduce corrosion and maintain pressure on the influent to prevent the water in the influent from entering the gas phase during alkaline hydrolysis;
a heater operable to heat the influent to a temperature within the range of 100° Celsius to 700° Celsius; and
a catalyst comprising:
a body operable to increase the rate at which alkaline hydrolysis separates a fluorine atom from a PFA compound when the body is disposed in an influent experiencing alkaline hydrolysis, wherein:
the body includes a transition metal, and
the body has:
a shape configured to enhance, during alkaline hydrolysis in the reactor vessel, a surface-area-to-volume ratio when the body is disposed in an influent experiencing alkaline hydrolysis,
wherein the surface area of the ratio includes the surface area of the body's shape and the surface area of the reactor vessel, that the influent contacts when the influent experiences alkaline hydrolysis,
wherein the volume of the ratio includes the volume of the influent experiencing alkaline hydrolysis in the reactor vessel, and
wherein the shape multiplies the surface-area-to-volume ratio by at least 1.5.

11. The system of claim 10 wherein the reactor vessel is configured to allow the alkaline hydrolysis to separate a fluorine atom from the PFA compound in the influent while the influent continuously flows through the reactor vessel.

12. The system of claim 10 wherein the reactor vessel includes an alloy that includes nickel.

13. (canceled)

14. The system of claim 10 wherein:
the catalyst includes a material that has a standard reduction potential that is less than the material included in the reactor vessel operable to provide cathodic protection to the reactor vessel, and
the catalyst is releasably held in the reactor vessel.

15. (canceled)

16. (canceled)

17. A method for breaking down a PFA (perfluoroalkyl or polyfluoroalkyl) compound, the method comprising:
adding an alkali to a solution that includes a PFA compound to generate a mixture;
heating the influent to a temperature within the range of 100° Celsius to 700° Celsius;
pressurizing the influent to a pressure that prevents the water in the influent from entering the gas phase;
holding the influent in a reactor vessel that includes a catalyst disposed in the influent;
maintaining the temperature and pressure of the influent for a period of time to separate a fluorine atom from the PFA compound via alkaline hydrolysis.

18. The method of claim 17 wherein the alkali includes at least one of the following: sodium hydroxide (NaOH), potassium hydroxide (KOH), and ammonium hydroxide (NH₄OH).

19. The method of claim 17 where in the pH of the influent is greater than 13.

20. The method of claim 17 wherein the amount of alkali added is within the range of 0.01 Moles per liter to 10 Moles per liter.

21. (canceled)

22. The method of claim 17 wherein the catalyst held in the reactor vessel includes a body that:
includes a transition metal, and
has a shape configured to enhance, during alkaline hydrolysis in the reactor vessel, a surface-area-to-volume ratio when the body is disposed in an influent experiencing alkaline hydrolysis, wherein:
the surface area of the ratio includes the surface area of the body's shape and the surface area of the reactor vessel, that the influent contacts when the influent experiences alkaline hydrolysis,
the volume of the ratio includes the volume of the influent experiencing alkaline hydrolysis in the reactor vessel, and
the shape multiplies the surface-area-to-volume ratio by at least 1.5.

23. The method of claim 17 wherein the reactor vessel includes a material and the catalyst held in the reactor vessel includes a different material that has a standard reduction potential that is less than the reactor's material, such that the catalyst also provides the reactor vessel cathodic protection.

24. (canceled)

25. The method of claim 17 wherein the temperature that the influent is heated to is within the range of 150° to 350° Celsius.

26. The method of claim 17 wherein the pressure exerted on the influent is 10 MPa.

27. The method of claim 17 wherein the temperature and pressure of the influent is maintained for 1 to 10 minutes.

28. (canceled)

29. A system for breaking down a PFA (perfluoroalkyl or polyfluoroalkyl) compound, the system comprising:
a reactor vessel operable to hold influent that includes:
a PFA compound,
an alkali, and
water
while alkaline hydrolysis separates a fluorine atom from the PFA compound in the influent, wherein, the reactor vessel is sized and configured to reduce corrosion and maintain pressure on the influent to prevent the water in the influent from entering the gas phase during alkaline hydrolysis;
a heater operable to heat the influent to a temperature within the range of 100° Celsius to 700° Celsius;
a throttling device located downstream from the reactor vessel and operable to turn the liquid water in the effluent from the reactor vessel into a vapor-liquid mixture;
a tank operable to separate the vapor from the liquid portion in the effluent; and
a pump operable to move the liquid portion of the effluent from the tank back toward another PFA compound for mixing and subsequent alkaline hydrolysis in the reactor vessel.

30. The system of claim 29 wherein the throttling device includes a capillary tube.

31. The system of claim 29 further comprising a catalyst disposed in the reactor vessel, the catalyst comprising:
a body operable to increase the rate at which alkaline hydrolysis separates a fluorine atom from a PFA compound when the body is disposed in an influent experiencing alkaline hydrolysis, wherein:
the body includes a transition metal, and
the body has:
a shape configured to enhance, during alkaline hydrolysis in the reactor vessel, a surface-area-to-volume ratio when the body is disposed in an influent experiencing alkaline hydrolysis,
wherein the surface area of the ratio includes the surface area of the body's shape and the surface area of the reactor vessel, that the influent contacts when the influent experiences alkaline hydrolysis,
wherein the volume of the ratio includes the volume of the influent experiencing alkaline hydrolysis in the reactor vessel, and
wherein the shape multiplies the surface-area-to-volume ratio by at least 1.5.

32. The system of claim 29 further comprising at least one of the following:
a heat exchanger operable to recuperate heat from the effluent leaving the tank.
a nanofiltration membrane operable to remove impurities from the liquid effluent leaving the tank, and
a condenser operable to convert vapor leaving the tank into liquid.

33. (canceled)

34. (canceled)

35. A method for breaking down a PFA (perfluoroalkyl or polyfluoroalkyl) compound, the method comprising:
adding an alkali to a solution that includes a PFA compound to generate a mixture;
heating the influent to a temperature within the range of 100° Celsius to 700° Celsius;
pressurizing the influent to a pressure that prevents the influent from entering the gas phase;
holding the influent in a reactor vessel;
maintaining the temperature and pressure of the influent for a period of time to separate a fluorine atom from the PFA via alkaline hydrolysis and to generate an effluent;
reducing the pressure of the effluent to generate a saturated vapor-liquid mixture;
separating the vapor phase of the mixture from the liquid phase while holding the saturated vapor-liquid mixture in a tank;
adding the liquid phase of the mixture to a substance that includes PFA to recycle alkali previously used.

36. The method of claim 35 wherein the influent flows through the reactor vessel while the temperature and pressure are maintained to separate a fluorine atom from the PFA compound.

37. The method of claim 35 further comprising:
condensing the vapor separated from the liquid-vapor mixture into the liquid phase, and
recycling the liquid.

38. The method of claim 35 further comprising recuperating heat from the liquid phase to be used for heating subsequent influent.

39. (canceled)

40. The method of claim 35 wherein holding the influent in the reactor vessel includes holding the influent in a reactor vessel that includes a catalyst.

41. The system of claim 10 wherein the catalyst shape includes at least one of the following:
an interior passage through which influent flows around the body while the influent experiences alkaline hydrolysis,
a mesh,
a helix, and
a shape having a surface area that is 12 to 110 times the volume of the catalyst's body.
